(19) United States
(12) Patent Application Publication
(10) Pub. No.: US 2007/0283965 A1
(43) Pub. Date: Dec. 13, 2007

(54) Sex aid to prevent full penetration during sexual intercourse

(76) Inventors: Melissa Foks, London (GB); Emily Dawe, London (GB)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/449,296

(22) Filed: Jun. 8, 2006

(51) Int. Cl. A61G 15/00

(52) U.S. Cl. 128/845

(57) ABSTRACT

A sex aid, constructed and shaped in such a way as to comfortably prevent the penis from fully entering the vagina during sexual intercourse, thereby preventing the tip of the penis from impacting on the cervix and causing pain. The sex aid is designed to solve a specific problem relating to painful sexual intercourse between heterosexual couples when the man's penis is longer than average and or the woman's cervix is lower than average and/or the woman uses an inter-uterine device. The sex aid comprises a pad that rests between the man's and woman's pubis during sexual intercourse. There are two versions of the sex aid: one comprises a pad that is constructed as a ring that fits over the penis, the other comprises a pad that is incorporated into a pair of briefs and worn by the woman.

### BACKGROUND

1. Technical Field

The invention relates to a sex aid designed to solve a specific problem relating to painful sexual intercourse between heterosexual couples when the man's penis is longer than average and/or the woman's cervix is lower than average (and/or may be encumbered by the use of an inter-uterine device).

2. Background of Related Art

During sexual intercourse, full penetration can cause extreme discomfort to the woman when the glans of the penis impacts on the cervix, sending a shooting pain through the woman's body and, further, discomfort may be experienced by the man should the glans impact upon an inter-uterine device within the woman.

In partnerships where the length of penis/height of cervix are incompatible there are various suggested techniques for achieving a rewarding sexual experience. These rely on avoiding full penetration. There does not appear to be any product, currently on the market, which allows the couple to experience the pleasurable sensation of full penetration without the pain.

An object of this invention is to allow those partnerships where the length of penis/height of cervix is incompatible to experience the pleasurable sensation of full penetration whilst ensuring that the end of the penis cannot impact on the cervix.

### SUMMARY

Accordingly, this invention provides a sex aid comprising a resilient buffer pad for placement between a male and female pubis and configured to at least partially surround the penis during intercourse to keep the male and female pubis spaced apart by a minimum spacing so as to prevent the penis from fully entering the vagina thereby preventing the tip of the penis from impacting on the cervix during intercourse.

The buffer pad preferably includes an aperture through which the penis extends in use. Furthermore, the buffer pad may be adjustable in thickness and is preferably inflatable. The buffer pad may also be made of silicone rubber.

In a preferred embodiment, the buffer pad is ring-shaped having a central aperture and is constructed to fit over the penis and remain at the base thereof during intercourse. Preferably, the buffer pad includes a ring formed integrally therewith around the central aperture, and the ring may be expandable.

In another preferred embodiment, the buffer pad is incorporated into a pair of underwear briefs for being worn by a woman and is positioned therein such that, in use, the buffer pad surrounds the vagina and, said briefs include an aperture therein to allow the penis to enter the vagina through the briefs and past the buffer pad.

The invention preferably comprises a fleshy pad that rests between the male and female pubis during sexual intercourse.

The present invention can take the form of at least two different embodiments, one embodiment designed to be worn by the man and one designed to be worn by the woman. Both comprise a pad of sufficient thickness to prevent the penis fully entering the vagina and impacting on the cervix during intercourse. The man's buffer device is preferably constructed as a ring that fits over the penis, whereas the woman's is preferably worn like a pair of briefs, with the pad secured to the briefs.

Preferably, the buffer device is made from a material that most closely simulates natural flesh, such as those materials currently used in prosthetics and it may also be inflatable and/or disposable.

### BRIEF DESCRIPTION OF THE DRAWINGS

A preferred embodiment of the invention will now be described, with reference to the accompany drawings, in which:

FIG. 1 shows a plan view of a sex aid of the present disclosure to be worn by a man;

FIG. 2 shows a cross-sectional side view, as taken through A-A of FIG. 1 of the sex aid to be worn by a man;

FIG. 3 shows a plan view of a sex aid of the present disclosure to be worn by a woman;

FIG. 4 shows a perspective drawing of the sex aid of FIG. 3 to be worn by a woman; and

FIG. 5 shows a diagrammatic image of the sex aid in use.

### DETAILED DESCRIPTION OF EMBODIMENTS

As shown in FIGS. 1 and 2, a sex aid 10 according to a first embodiment of the present invention is shown, and comprises a pad 1, configured to cover the pubic area and constructed as a ring 2, that expands to fit the girth at the base of the penis shaft. The sex aid 10 is thus worn by the man “M” and remains close to his body during intercourse. The pad 1 may be constructed from silicone or similar material, and may be inflatable.

FIG. 2 shows that the fleshy pad 1 is contoured in such a way and is sufficiently thick to have the effect of preventing the full length of the penis from entering the vagina.

FIG. 3 shows a second embodiment of sex aid 10 of the present invention, designed to be worn by a woman “W”, and which is incorporated into a pair of briefs 3, which are done up around the woman's waist with ties 4. There is a hole in the briefs 3 to provide an entry point 5 for the penis to pass through the briefs 3, through the pad 1 and into the vagina.

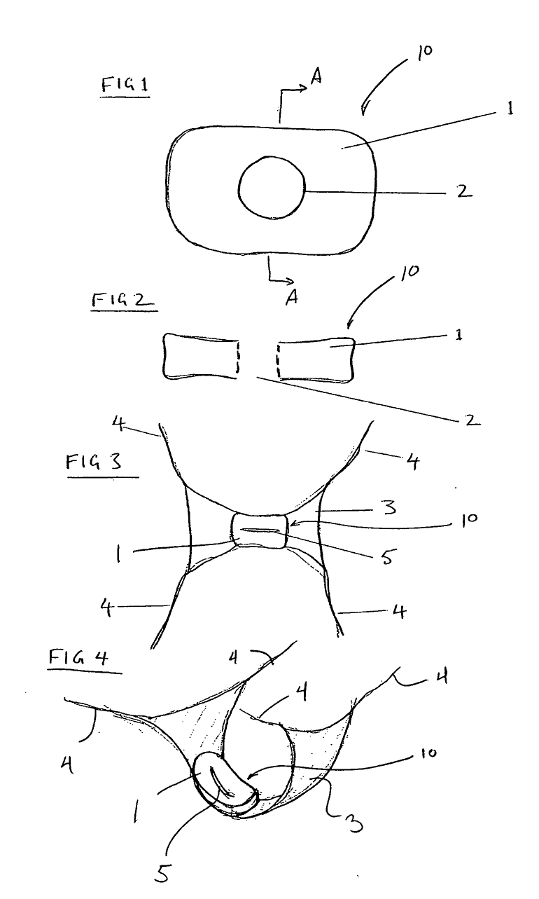

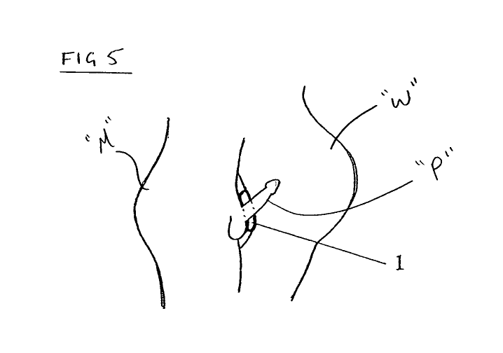

FIG. 4 shows a perspective drawing of FIG. 3.

FIG. 5 schematically shows the effect of the sex aid 10, of either the women's “W” and/or men's “M” embodiments, which is to prevent the penis “P” from fully entering the vagina by spacing the man's “M” and woman's “W” pubis apart by a minimum spacing distance, thereby preventing the tip of the penis “P” from impacting on the woman's “W” cervix which can cause extreme discomfort during intercourse.

What is claimed is:

1. A sex aid comprising:
a resilient buffer pad for placement between a male and female pubis and configured to at least partially surround the penis during intercourse to keep the male and female pubis spaced apart by a minimum spacing so as to prevent the penis from fully entering the vagina thereby preventing the tip of the penis from impacting on the cervix during intercourse.

2. A sex aid according to claim 1, wherein the buffer pad includes an aperture through which the penis extends in use.

3. A sex aid according to claim 1, wherein the buffer pad is adjustable in thickness.

4. A sex aid according to claim 1, wherein the buffer pad is inflatable.

5. A sex aid according to claim 1, wherein the buffer pad is made of silicone rubber.

6. A sex aid according to claim 1, wherein the buffer pad is ring-shaped having a central aperture and is constructed to fit over the penis and remain at the base thereof during intercourse.

7. A sex aid according to claim 6, wherein the buffer pad includes a ring formed integrally therewith around the central aperture.

8. A sex aid according to claim 7, wherein the ring is expandable.

9. A sex aid according to claim 1, wherein the buffer pad is incorporated into a pair of underwear briefs for being worn by a woman and is positioned therein such that, in use, the buffer pad surrounds the vagina and, said briefs include an aperture therein to allow the penis to enter the vagina through the briefs and past the buffer pad.

10. A sex aid to be worm by a male or female user, the sex aid comprising:
a buffer pad defining an opening therethrough to placement of a penis of the male therein, wherein during insertion of the penis of the male into the vagina of the female the buffer pad prevents full insertion of the penis into the vagina.

11. A sex aid according to claim 10, further comprising a panty brief supporting the buffer pad thereon, wherein the panty brief includes an entry point formed therein which is in registration with the opening of the buffer pad.

12. A sex aid according to claim 10, wherein the buffer pad is made of silicone rubber.
